(19) United States
(12) Patent Application Publication
(10) Pub. No.: US 2010/0091203 A1
(43) Pub. Date: Apr. 15, 2010

(54) OPTICAL WRITING APPARATUS, OPTICAL WRITING METHOD, AND RECORDING MEDIUM

(75) Inventors: Hideo KOBAYASHI, Kanagawa (JP); Yasuhiro YAMAGUCHI, Kanagawa (JP); Hiroe OKUYAMA, Kanagawa (JP); Naoki HIJI, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/481,788

(22) Filed: Jun. 10, 2009

(30) Foreign Application Priority Data
Oct. 10, 2008 (JP) 2008-263711

(51) Int. Cl. G02F 1/1335

(52) U.S. Cl. 349/12

(57) ABSTRACT

An optical writing apparatus includes an irradiation unit which irradiates a writing light on an optical writing image display medium comprising a photoconductor layer and a display layer, a voltage applying unit which applies an image writing pulse voltage to the display layer and the photoconductor layer, and a control unit. The control unit controls the irradiation unit such that, at a first time interval at which the writing light is irradiated, the writing light is irradiated on the photoconductor layer, and controls the voltage applying unit such that a first pulse voltage is applied at an interval which is longer than the first time interval, and such that a second pulse voltage whose polarity is opposite to a polarity of the first pulse voltage and whose absolute value is larger than an absolute value of the first pulse voltage is applied after application of the first pulse voltage.

### CROSS-REFERENCE TO RELATED APPLICATION

This application is based on and claims priority under 35 USC 119 from Japanese Patent Application No. 2008-263711 filed Oct. 10, 2008.

### BACKGROUND

1. Technical Field

The present invention relates to an optical writing apparatus, optical writing method, and a recording medium.

2. Related Art

A recording apparatus which writes information with light to a recording element including a display member, a photoconductive member arranged to be superposed on the display member, and one pair of electrodes arranged on both sides of the display member and the photoconductive member is known.

A conventional optical record driving method which drives an optical recording element including an optical photoconductive member having a charge generating layer, a liquid crystal layer mainly containing a liquid crystal which forms a cholesteric phase, and one pair of first and second electrodes arranged to sandwich the organic photosensitive member and the liquid crystal layer is known.

### SUMMARY

The present invention provides an optical writing apparatus, optical writing method, and a recording medium in which a portion, displaying an image on which writing light is irradiated, has a high reflectance.

An aspect of the invention provides an optical writing apparatus including: an irradiation unit which irradiates a writing light on a photoconductor layer of an optical writing image display medium, the optical writing image display medium comprising the photoconductor layer, which has an electrical resistance which is changed according to a light amount of an irradiated writing light, and further comprising a display layer which displays an image by reflecting and transmitting light having a wavelength according to a magnitude of a voltage applied through the photoconductor layer; a voltage applying unit which applies an image writing pulse voltage to the display layer and the photoconductor layer; and a control unit which, at the time of image writing, controls the irradiation unit such that, at a first time interval at which the writing light is irradiated, the writing light is irradiated on the photoconductor layer, and which controls the voltage applying unit such that a first pulse voltage is applied to the display layer and the photoconductor layer at an interval which is longer than the first time interval, and such that a second pulse voltage whose polarity is opposite to a polarity of the first pulse voltage and whose absolute value is larger than an absolute value of the first pulse voltage is applied after application of the first pulse voltage.

### BRIEF DESCRIPTION OF THE DRAWINGS

Exemplary Embodiments of the present invention will be described in detail based on the following figures, wherein:

FIG. 1 is a sectional view of a display medium.

FIG. 2 is a schematic configuration diagram of an image display apparatus (optical writing apparatus).

FIG. 3 is a circuit diagram showing an equivalent circuit of a display medium.

FIG. 4A is an explanatory pattern diagram showing a relationship between a molecular orientation and an optical characteristic of a cholesteric liquid crystal in a planar phase.

FIG. 4B is an explanatory pattern diagram showing a relationship between a molecular orientation and an optical characteristic of the cholesteric liquid crystal in a focal-conic phase.

FIG. 4C is an explanatory pattern diagram showing a relationship between a molecular orientation and an optical characteristic of a cholesteric liquid crystal in a homeotropic phase.

FIG. 5 is a graph for explaining a switching behavior of the cholesteric liquid crystal.

FIG. 6 is a chart showing waveforms of a reset pulse voltage and an image writing pulse voltage in a first exemplary embodiment.

FIG. 7 is a graph showing an experimental result.

FIG. 8 is a chart showing waveforms of a reset pulse voltage and an image writing pulse voltage in a second exemplary embodiment.

FIG. 9 is a graph showing an experimental result.

FIG. 10 is a graph showing an experimental result.

FIG. 11 is a circuit diagram showing a modification of a voltage applying unit.

### DETAILED DESCRIPTION

Exemplary embodiments of the present invention will be described below.

### First Exemplary Embodiment

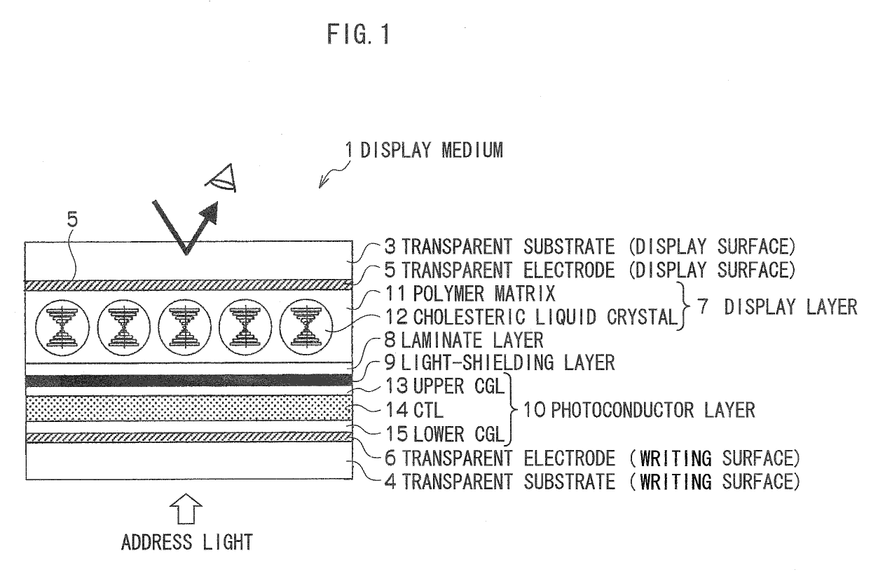

A first exemplary embodiment will be described first. FIG. 1 shows a sectional view of an optical writing display medium 1 in this exemplary embodiment. The display medium 1 is a display medium on which an image may be recorded by irradiation of address light according to the image and application of a pulse voltage (bias signal).

As shown in FIG. 1, the display medium (optical writing image display medium) 1 is configured by sequentially laminating a transparent substrate 3, a transparent electrode 5, a display layer (liquid crystal layer) 7, a laminate layer 8, a light-shielding layer (color layer) 9, a photoconductor layer 10, a transparent electrode 6, and a transparent substrate 4 from a display surface side.

The transparent substrates 3 and 4 holds functional layers therebetween to maintain a structure of a display medium. The transparent substrates 3 and 4 are configured by sheet-like members having the strength to withstand external force. The transparent substrate 3 on the display surface side transmits at least incident light, and the transparent substrate 4 on the writing surface side transmits at least address light (writing light). The transparent substrates 3 and 4 preferably have flexibility. Specific materials may include an inorganic sheet (for example, glass or silicon), a polymer film (for example, polyethylene terephthalate, polysulfone, polyether sulfone, polycarbonate, or polyethylene naphthalate). On the exterior, a known functional film such as an anti-fouling film, an abrasion-resistant film, an anti-reflective film, a gas-barrier film, or the like may be formed.

The transparent substrates 3 and 4 have transparencies over an entire visible light range in the exemplary embodiment. However, the transparent substrates 3 and 4 have transparencies in only a wavelength range which allows an image to be displayed.

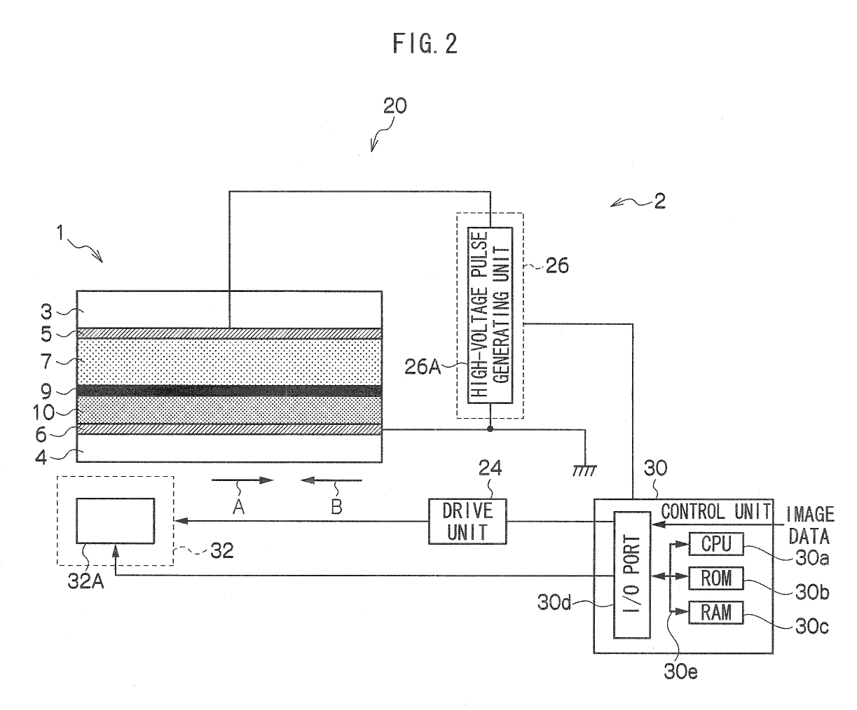

The transparent electrodes 5 and 6 are used to apply a pulse voltage (bias voltage) applied from an optical writing apparatus (optical recording apparatus) 2 shown in FIG. 2 to the functional layers in the display medium 1. Each of the transparent electrode 5 and the transparent electrode 6 is configured by a single transparent electrode having an area corresponding to an entire surface of the display medium 1. The transparent electrodes 5 and 6 ideally have in-plane-uniform conductivity. The transparent electrode 5 on the display surface side transmits at least incident light, and the transparent electrode 6 on the writing surface side transmits at least address light. More specifically, a conductive thin film mainly consisting of a metal (for example, gold or aluminum), a metal oxide (for example, indium oxide, tin oxide, or indium tin oxide (ITO)), a conductive organic polymer (for example, polythiophenes or polyanilines), or the like may be given. On the surfaces of the transparent electrodes 5 and 6, known functional films such as an adhesion-improving film, an anti-reflection film, and a glass-barrier film may be formed.

The transparent electrodes 5 and 6 have transparencies over an entire visible light range in the exemplary embodiment. However, the transparent electrodes 5 and 6 have transparencies in only a wavelength range which allows an image to be displayed.

The display layer 7 has a function which modulates reflection and transmission states of specific-color light of incident lights according to an electric field and may naturally hold a selected state in a non-electric field. The display layer 7 preferably has a structure which is not deformed by an external force such as bending or pressure. The display layer 7 displays an image by reflecting and transmitting light having a wavelength according to a magnitude of a voltage applied through the photoconductor layer 1I which will be described in detail later.

In the exemplary embodiment, the display layer 7 is configured by a liquid crystal layer of a self-holding type liquid crystal composite including, for example, a cholesteric liquid crystal and a transparent resin. More specifically, since the composite has a self-holding characteristic, the liquid crystal layer does not require a spacer or the like. However, the liquid crystal layer is not limited to the liquid crystal according to the exemplary embodiment. In the exemplary embodiment, as shown in FIG. 1, cholesteric liquid crystals 12 are diffused in a polymer matrix (transparent resin) 11.

The cholesteric liquid crystal 12 has a function of modulating a reflecting/transmitting state of specific-color light of the incident lights. In the cholesteric liquid crystal 12, liquid crystal molecules are oriented to be helically twisted, and a specific light according to a helical pitch among the incident lights of a helical axis direction is interferentially reflected. An orientation changes according to an electric field to make it possible to change a reflection state. In a color display, cholesteric liquid crystals are preferably densely arranged in a single layer to each have uniform drop sizes.

A specific concrete liquid crystal which may be used as the cholesteric liquid crystal 12 includes a material obtained by adding a chiral agent (for example, a steroidal cholesterol derivative, a Schiff base, an azo, an ester, or a biphenyl compound) to a nematic liquid crystal or a smectic liquid crystal (for example, a Schiff base, an azo, an azoxy, a benzoic ester, a biphenyl, a terphenyl, a cyclohexyl carboxylic acid ester, a phenylcyclohexane, a biphenylcyclohexane, a pyrimidine, a dioxane, a cyclohexylcyclohexane ester, cyclohexylethane, a cyclohexane, a tran, an alkenyl, a stilbene, or a fused polycyclic compound), or mixtures thereof.

The helical pitch of the cholesteric liquid crystal is adjusted by an amount of chiral agent added to a nematic liquid crystal. For example, when display colors are blue, green, and red, central wavelengths of selected reflections are set to fall within the ranges of 400 nm to 500 nm, 500 nm to 600 nm, and 600 nm to 700 nm. In order to compensate for a temperature dependence of the helical pitch of the cholesteric liquid crystal, a known method of adding a plurality of chiral agents having different helical directions or opposite temperature dependencies may be used.

As a configuration in which the display layer 7 forms a self-holding type liquid crystal composite including the cholesteric liquid crystal 12 and the polymer matrix (transparent resin) 11, a PNLC (Polymer Network Liquid Crystal) structure containing a network resin in a continuous phase of the cholesteric liquid crystal or a PDLC (Polymer Dispersed Liquid Crystal) structure (which may be microencapsulated) in which cholesteric liquid crystals are dispersed in a skeleton of a polymer in a droplet form may be used. By using the PNLC structure or the PDLC structure, an anchoring effect occurs on an interface between the cholesteric liquid crystal and the polymer to make it possible to make a holding state of a planar phase or a focal-conic phase in a non-electric field more stable.

The PNLC structure and the PDLC structure may be formed by a known method which phase-separates a polymer and a liquid crystal from each other, for example, a PIPS (Polymerization Induced Phase Separation) method which mixes a polymer precursor such as an acrylic, a thiol, or an epoxy with a liquid crystal which are polymerized by heat, light, an electron beam, or the like, and polymerizes the polymer precursor and the liquid crystal in a homogeneous phase state to cause phase separation, an emulsion method which mixes a polymer such as polyvinyl alcohol having a low solubility in a liquid crystal, stirs and suspends the mixture to droplet-disperse the liquid crystal in the polymer, a TIPS (Thermally Induced Phase Separation) method which mixes a thermoplastic polymer and a liquid crystal with each other, heats the mixture in a homogeneous phase state, and cools the heated mixture to cause phase separation, and an SIPS (Solvent Induced Phase Separation) method which solves a polymer and a liquid crystal in a solvent such as chloroform, evaporate the solvent to cause phase separation, or the like. However, the method is not limited to a specific method.

The polymer matrix 11 holds the cholesteric liquid crystal 12 and has a function of suppressing fluidity (change of image) of the liquid crystal by deformation of a display medium. As the material of the polymer matrix 11, a polymer material which is not solved in a liquid crystal material and uses a liquid which is not compatible with the liquid crystal is preferably used. As the polymer matrix 11, a material which has strength to withstand external force and a high transparency to at least reflected light and address light is desirably used.

A material which may be employed as the polymer matrix 11 includes a water-soluble polymer material (for example, gelatine, polyvinyl alcohol, a cellulose derivative, polyacrylic acid macromolecule, ethyleneimine, polyethylene oxide, polyacrylamide, polystyrenesulfonate, polyamidine, or isoprene sulfonic acid polymer), a material which may be made into an aqueous emulsion (for example, fluorocarbon resin, silicon resin, acrylate resin, urethane resin, or epoxy resin), or the like.

The photoconductor layer 10 is a layer having an internal photoelectric effect and a characteristic in which an impedance characteristic changes according to an irradiation intensity of address light. The photoconductor layer 10 which may be operated by an AC voltage is preferably symmetrically driven with respect to address light. Further, a three-layer structure in which charge generation layers (CCL) are laminated on the upper and lower sides of a charge transport layer (CTL) is preferably used. In the exemplary embodiment, the photoconductor layer 10 is obtained by sequentially laminating, for example, an upper charge generating layer 13, a charge transport layer 14, and a lower charge generating layer 15 from the upper side in FIG. 1. The photoconductor layer 10 has an electric resistance which changes according to an amount of irradiated writing light.

Each of the charge generating layers 13 and 15 has a function of absorbing address light to generate optical carriers. Principally, the charge generating layer 13 controls the number of optical carriers flowing from the transparent electrode 5 on the display surface side (display layer 7 side) to the transparent electrode 6 on a writing surface side (photoconductor layer 10 side), and the charge generating layer 1 5 controls the number of optical carriers flowing from the transparent electrode 6 on the writing surface side to the transparent electrode 5 on the display surface side. As each of the charge generating layers 13 and 15, a charge generating layer which absorbs address light to generate excitons and efficiently separate the excitons to free carriers in the charge generating layer or on the interface between the charge generating layer and the charge transport layer is preferably used.

Each of the charge generating layers 13 and 15 may be formed by a dry method which directly form a film of a charge generating material (for example, a metal or metal-free phthalocyanine such as chlorogallium phthalocyanine and hydroxygallium phthalocyanine, a squarium compound, an azrenium compound, a perylene pigment, an indigo pigment, an,azo pigment such as bis- or tris-, a Quinacridone pigment, a pyrolopyrrole dye, a polycyclic quinone pigment, a fused aromatic pigment such as dibromoanthanthrone, a cyanine dye, a xanthene pigment, a charge-transfer complex such as polyvinylcarbazole and nitrofluoren, and a eutectic complex consisting of a pyrylium salt dye and a polycarbonate resin), a wet application method which disperses or solves these charge generating materials in an appropriate solvent together with a polymer binder (for example, a polyvinyl butyral resin, a polyalylate resin, a polyester resin, a phenolic resin, a vinylcarbazole resin, a vinyl formal resin, a partial denaturation vinyl acetal resin, a carbonate resin, an acrylic resin, a vinyl chloride resin, a styrene resin, a vinyl acetate resin, a polyvinyl acetate resin, a silicone resin, or the like) to prepare an application liquid, applies and dries the application liquid to form a film.

The charge transport layer 14 is a layer into which the optical carriers generated in the charge generating layers 13 and 15 are injected and has a function of drifting the optical carriers in an electric field direction applied by a bias signal. In general, since the charge transport layer 14 has a thickness approximately several ten times the thickness of a charge generating layer, a capacity of the charge transport layer 14, a dark current of the charge transport layer 14, and an optical carrier current in the charge transport layer 14 determine bright and dark impedances of the entire photoconductor layer 10.

As the charge transport layer 14, a layer in which injection of free carriers from the charge generating layers 13 and 15 efficiently occurs (the ionization potential is preferably similar to that of the charge generating layers 13 and 15) and the injected free carriers hopping-move as fast as possible is preferably used. In order to increase an impedance in a dark current state, a dark current caused by hot carriers is preferably set to be low.

The charge transport layer 14 may be formed such that a material obtained by dispersing or solving a low-molecular-weight hole transport material (for example, a trinitrofluorene compound, a polyvinylcarbazole compound, an oxadiazole compound, or a hydrazone compound such as a benzylamino hydrazone or a quinoline hydrazone, a stilbene compound, a triphenylamine compound, a triphenylmethane compound, or a benzidine compound) or a low-molecular-weight electron transport material (for example, a quinone compound, a tetracyanoquinodimethane compound, a fluorenone compound, a xanthone compound, or a benzophenone compound) in an appropriate solvent together with a polymer binder (for example, a polycarbonate resin, a polyarylate resin, a polyester resin, a polyimide resin, a polyamide resin, a polystyrene resin, a silicon-containing crosslinked resiii) or a material obtained by dispersing or solving a material polymerized with the hole transport material or the electron transport material in an appropriate solvent may be prepared, applied, and dried.

The light-shielding layer (color layer) 9 is a layer which is arranged to optically separate address light and incident light in a writing state, to prevent an erroneous operation caused by an interaction, to optically separate external light being incident from a non-display surface side of the display medium in a display state, and to prevent image quality from being deteriorated. For this purpose, the light-shielding layer 9 requests a function of absorbing at least light in an absorbing wavelength region of the charge generating layer and light in a reflecting wavelength region of the display layer.

More specifically, the light-shielding layer 9 may be formed by a dry method which directly forms a film of an inorganic pigment (for example, a cadmium pigment, a chromium pigment, a cobalt pigment, a manganese pigment, or a carbon pigment) or an inorganic dye or an inorganic pigment (for example, an azo pigment, an anthraquinone pigment, an indigo pigment, a triphenylmethane pigment, a nitro pigment, a phthalocyanine pigment, a perylene pigment, a pyrolopyrrole pigment, a Quinacridone pigment, a polycyclic quinone pigment, a squarium pigment, an azrenium pigment, a cyanine pigment, a pyrylium pigment, or an anthrone pigment) on a surface of the photoconductor layer 10 at the charge generating layer 13 side, or a wet application method which disperses or solves these pigments in an appropriate solvent together with a polymer binder (for example, a polyvinyl alcohol resin, a polyacrylic resin, or the like) to prepare an application liquid and applies and dries the application liquid to form a film, or the like.

The laminate layer 8 is a layer to play a role of absorbing unevenness and adhering the functional layers when the functional layers formed on the internal surfaces of the upper and lower substrates are bonded to each other. The laminate layer 8 is not a necessary constituent element in the exemplary embodiment. The laminate layer 8 consists of a polymer material having a low glass transition point. As the material, a material which may cause the display layer 7 and the color layer 9 to contact and adhere to each other with heat or pressure is selected. It is a condition for the material that the material has transparency to at least incident light.

A preferable material for the laminate layer 8 may include a sticky polymer material (for example, a urethane resin, an epoxy resin, or a silicone resin).

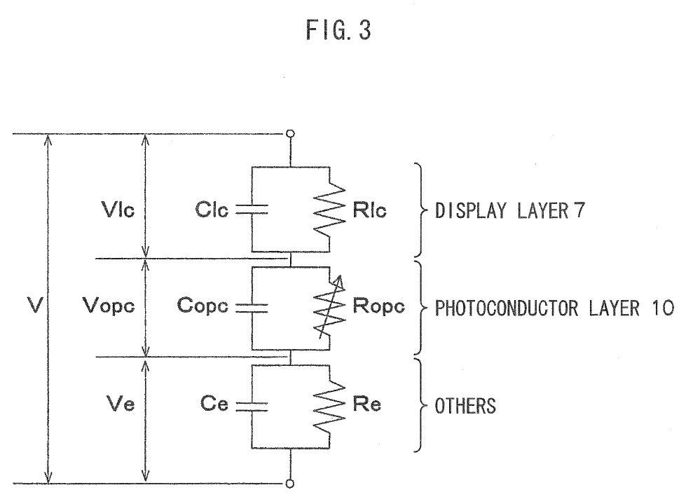

FIG. 3 is a circuit diagram showing an equivalent circuit of the display medium (liquid crystal device) 1 having the structure shown in FIG. 1. Reference symbols Clc, Copc, Rlc, and Rope denote electrostatic capacitances and resistances of the display layer 7 and the photoconductor layer 10, respectively. Reference symbols Ce and Re denote equivalent electrostatic capacitances and equivalent resistances of constituent elements except for the display layer 7 and the photoconductor layer 10, respectively.

It is assumed that a voltage applied from the external optical writing apparatus 2 across the transparent electrode 5 and the transparent electrode 6 of the display medium 1 is represented by V. In this case, to the constituent elements, divided voltages Vlc, Vope, and Ve determined by impedance ratios of the constituent elements are applied. More specifically, immediately after the voltages are applied, divided voltages determined by capacitance ratios of the constituent elements are generated. The divided voltages reduce to voltages determined by resistance ratios of the constituent elements with the lapse of time.

In this case, since the resistance Ropc of the photoconductor layer 10 changes according to an intensity (light amount) of address light, an effective voltage applied to the display layer 7 by exposing/unexposing may be controlled. In an exposure state, the resistance Ropc of the photoconductor layer 10 decreases, and the effective voltage applied to the display layer 7 increases. In contrast to this, in an unexposing state, the resistance Rope of the photoconductor layer 10 increases, and the effective voltage applied to the display layer 7 decreases.

The cholesteric liquid crystal (chiral nematic liquid crystal) 12 will be described below. A planar phase exhibited by the cholesteric liquid crystal 12 causes a selective reflecting phenomenon which splits light being incident parallel to a helical axis into right rotatory light and left rotatory light and Bragg-reflects a circularly polarized light component matched with a helical direction of the helical axis, and transmits remaining light. A central wavelength λ and a reflecting wavelength width Δλ are expressed by λ=n·p and Δλ=Δn·p where a helical pitch is p, an average refraction factor in a plane orthogonal to the helical axis is n, and a birefringence is Δn, and a reflected light obtained by a cholesteric liquid crystal layer at a planar phase exhibits a vivid color according to the helical pitch.

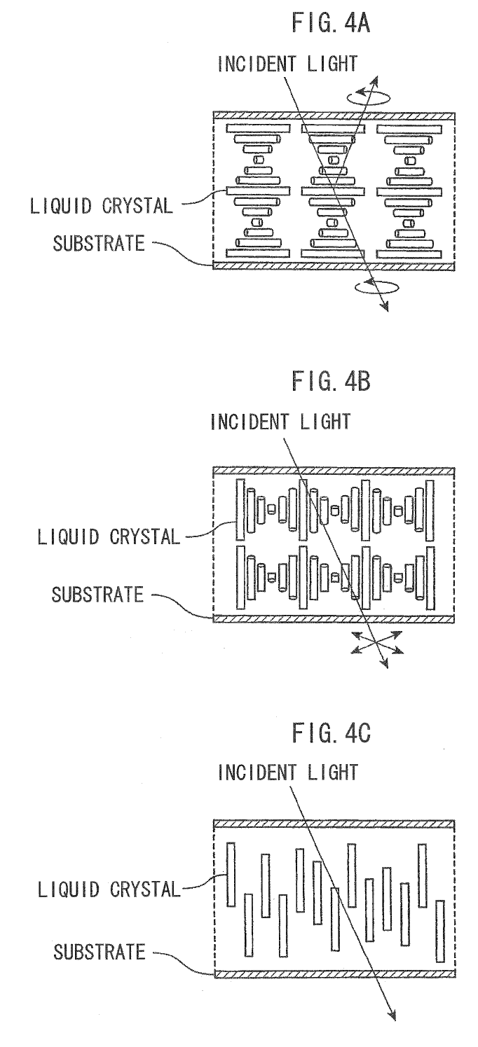

A cholesteric liquid crystal having a positive dielectric anisotropy exhibits three states, i.e., a planar phase which has a helical axis perpendicular to a cell surface as shown in FIG. 4A and causes the selective reflecting phenomenon to incident light, a focal-conic phase which has a helical axis almost parallel to the cell surface and transmits incident light while scattering the incident light a little, and a homeotropic phase in which a helical structure is loosened to set a liquid crystal director in an electric field direction, and transmits the incident light almost perfectly.

Of the three states, the planar phase and the focal-conic phase may be bistably present in a non-electric field. Therefore, the phase state of the cholesteric liquid crystal is not uniquely determined to an electric field intensity applied to the liquid crystal layer. When the planar phase is an initial state, with an increase in electric field intensity, the phase sequentially changes into the planar phase, the focal-conic phase, and the homeotropic phase. When the focal-conic phase is an initial state, with an increase in electric field intensity, the phase sequentially changes into the focal-conic phase and the homeotropic phase.

On the other hand, an electric field intensity applied to the liquid crystal is made zero, the planar phase and the focal-conic phase are kept, and the homeotropic phase changes into the planar phase.

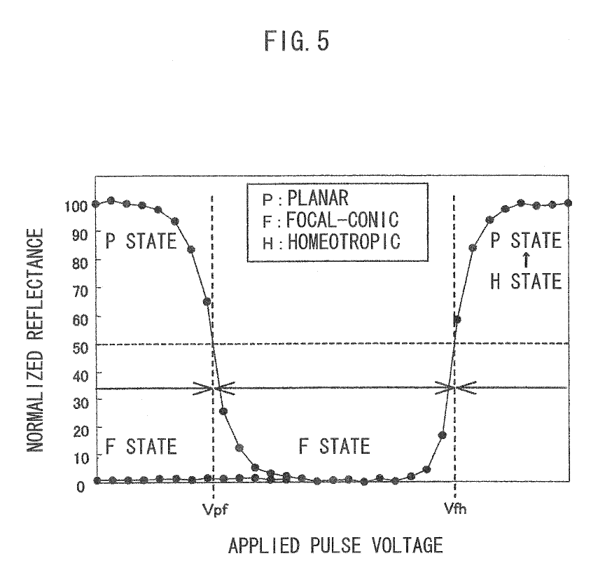

Therefore, a cholesteric liquid crystal layer obtained immediately after a pulse signal is applied exhibits a switching behavior as shown in FIG. 5. When the voltage of the applied pulse signal is Vfh or more, a selective reflection state in which the homeotropic phase changes into the planar phase is set. When the voltage is set between Vpf and Vfh, a transmission state obtained by the focal-conic phase is set when the voltage is Vpf or less, a state in which a state obtained before the pulse signal is applied is set, i.e., a selective reflection state obtained by the planar phase or a transmission state obtained by the focal-conic phase is set.

In the above drawings, an ordinate denotes a normalized reflectance. The maximum reflectance is set to 100, and the minimum reflectance is set to 0, so that the reflectance is normalized. Since transition regions are present between the states of the planar phase, the focal conic phase, and the homeotropic phase, a normalized reflectance of 50 or more is defined as a selective reflection state, and a normalized reflectance of less than 50 is defined as a transmission state. A threshold voltage of a phase change between the planar phase and the focal-conic phase is represented by Vpf, and a threshold voltage of a phase change between the focal-conic phase and the homeotropic phase is represented by Vfh.

In particular, in a liquid crystal layer including a PNLC (Polymer Network Liquid Crystal) structure containing a network resin in a continuous phase of the cholesteric liquid crystal or a PDLC (Polymer Dispersed Liquid Crystal) structure (which may be microencapsulated) in which cholesteric liquid crystals are dispersed in a skeleton of a polymer in a droplet form, as a result of interference at an interface between the cholesteric liquid crystal and the polymer (an anchoring effect), bistability of the planar phase and the focal-conic phase in a non-electric field is improved, and a state obtained immediately after a pulse signal is applied may be maintained for a long period of time.

In the display medium 1 using the cholesteric liquid crystal 12 with a bistability phenomenon, monochrome black-and-white display having a memory property in a non-electric field or a color display having a memory property in a non-electric field is performed by switching between the selective reflecting state (FIG. 4A) obtained by the planar phase and the transmission state (FIG. 4B) obtained by the focal-conic phase.

According to a magnitude of an externally applied voltage, when an initial state is a planar phase state (P state) or a homeotropic phase state (H state), the state of the cholesteric liquid crystal 12 changes into the P state, a focal-conic phase state (F state), and the H state. When an initial state is the F state, the state of the cholesteric liquid crystal 12 changes into the F state and the H state. When the final state is the P state and the F state, the P state and the F state are maintained after a voltage is not applied. However, the H state is changed into the P state. Therefore, regardless of an exposing/unexposing state, according to the magnitude of the applied voltage, the P state or the F state is selected as the final phase state. As shown in FIG. 5, an optical reflection state is set in the P state, and an optical transmitting state is set in the F state.

An image display apparatus 20 shown in FIG. 2 will be described below. The image display apparatus 20 includes the display medium 1 and the optical writing apparatus (optical recording apparatus) 2.

The optical writing apparatus 2 is an apparatus which writes (records) an image on the display medium 1. The optical writing apparatus 2 includes a light irradiation unit 32 which irradiates writing light (address light) on the display medium 1, a drive unit 24 which moves the light irradiation unit 32 in the directions of arrows A and B in FIG. 2 to relatively move the light irradiation unit 32 and the display medium 1, a voltage applying unit 26 including a high-voltage pulse generating unit 26A which generates a bias voltage (high-voltage pulse) to the display medium 1, and a control unit 30 which controls the drive unit 24, the voltage applying unit 26, and the light irradiation unit 32.

The light irradiation unit 32 includes a light source 32A which irradiates reset light to reset (initialize) the display medium 1 and irradiates writing light (optical image pattern) based on an input signal according to an image from the control unit 30 on the display medium 1 (more specifically, on the photoconductor layer 10). A reset light source which irradiates reset light may be arranged independently of the light irradiation unit 32. In this case, in the light irradiation unit 32, a light source which irradiates writing light on the display medium 1 is arranged. The light source 32A may include a fixed two-dimensional light source or a plurality of point light sources.

Resetting (initializing) of the display medium 1 means initialization of an orientation of a liquid crystal of, for example, the cholesteric liquid crystal 12. For example, the resetting (initialization) concretely means that the F state or the P state is set.

As writing light (address light) irradiated by the light source 32A, light having a peak intensity in an absorbing wavelength region of the photoconductor layer 10 and a narrow bandwidth is desirably used.

Since the light source 32A also irradiates reset light in the exemplary embodiment, a light source which may irradiates uniform light on the display medium 1 as reset light is desirably used.

As the light source 32A, for example, a light source obtained by arranging light sources such as cold cathode tubes, xenon lamps, halogen lamps, light-emitting diodes (LED), ELs, or lasers in a one-dimensional array, or a light source combined with polygon mirror, which may form an arbitrary two-dimensional light-emitting pattern by a scanning operation, is used. When the writing light is irradiated by the light source 32A from the photoconductor layer 10 side, an image may be written on the display layer 7.

The high-voltage pulse generating unit 26A is a circuit which generates a resetting pulse voltage and an image writing pulse voltage. As the high-voltage pulse generating unit 26A, for example, a high-voltage amplifier or the like which generates a resetting pulse voltage and an image writing pulse voltage may be used.

In the exemplary embodiment, as shown in FIG. 2, the transparent electrode 6 of the display medium 1 is grounded. Under the control of the control unit 30, the high-voltage pulse generating unit 26A applies an image writing pulse voltage (will be described in detail later) in an image writing state and applies a resetting pulse voltage having a negative polarity in a resetting state. More specifically, with respect to the electrode 5, the resetting pulse voltage applied to the grounded transparent electrode 6 has a negative polarity.

In this case, the voltage of the resetting pulse voltage is set to a voltage at which the display medium 1 may be reset (initialized) when the resetting pulse voltage is applied across the transparent electrode 5 and the transparent electrode 6 in a state in which a reset light is irradiated to the display medium 1 by the light source 32A, more specifically, for example, to a voltage at which an orientation of the liquid crystal of the cholesteric liquid crystal 12 may be initialized. For example, when initialization is performed in the F state, as shown in FIG. 5, a voltage (divided voltage) applied to the display layer 7 is larger than Vpf and smaller than Vfh. When initialization is performed in the P state, the voltage (divided voltage) applied to the display layer 7 is Vfh or more. For example, this voltage may be −650V.

A voltage (level) of the image writing pulse voltage is set to a voltage at which an image may be recorded on the display medium 1 when the image writing pulse voltage is applied across the transparent electrode 5 and the transparent electrode 6, in the state in which a writing light (image light) based on an image is irradiated on the display medium 1 by the light source 32A, and the state in which the irradiation of the writing light is ended. A waveform of the image writing pulse having the above voltage will be described in detail below.

According to a designation from the control unit 30, the drive unit 24 moves the light irradiation unit 32 in the direction of the arrow (sub-scanning direction) A and the direction of the arrow (sub-scanning direction) B in FIG. 2. The drive unit 24 includes, for example, a pulse motor or the like, and moves the light irradiation unit 32 in the directions of the arrows A and B in FIG. 2 by the drive of the pulse motor. In this manner, the light source 32A moves in the directions of the arrows A and B in FIG. 2. When the light irradiation unit 32 is configured to move, a configuration to detect a transparent electrode of the display medium 1 is not necessary. In comparison with the case in which the display medium 1 is moved, a connecting configuration to the voltage applying unit 26 becomes simple.

The control unit 30 includes a CPU (Central Processing Unit) 30a, a ROM (Read Only Memory) 30b, a RAM (Random Access Memory) 30c, an I/O (Input/Output) port 30d. The CPU 30a, the ROM 30b, the RAM 30c, and the I/O port 30d are connected to each other through a bus 30e. In the ROM 30b, a base program such as an OS and a program to execute a control process for controlling the entire optical writing apparatus 2 are stored. The CPU 30a reads a program from the ROM 30b to execute the program. In the RAM 30c, various data are temporarily stored. To the I/O port 30d, the drive unit 24, the voltage applying unit 26, and the light source 32A are connected.

The control unit 30 designates the drive unit 24 (controls the drive unit 24) to move the light irradiation unit 32 in the direction of the arrow B in FIG. 2 at a predetermined speed v (mm/s), controls the light source 32A to irradiate reset light on the display medium 1 by the light source 32A at a predetermined timing, and controls the voltage applying unit 26 such that the resetting pulse voltage is applied across the transparent electrode 5 and the transparent electrode 6 at the predetermined timing. In this manner, the display medium 1 is reset. An irradiation time (reset light irradiation time) T_{R} of the reset light is expressed by a value (L_{R}/v) obtained by dividing a moving distance L_{R} of the light irradiation unit 32 for the resetting by the speed v. The reset light irradiation time T_{R} described above is set when the light source 32A moves. When the light source 32A is a fixed light source, the reset light irradiation time T_{R} may be arbitrarily set.

The control unit 30 designates the drive unit 24 (controls the drive unit 24) to move the light irradiation unit 32 in the direction of the arrow A in FIG. 2 at a predetermined speed v′ (mm/s), controls the light source 32A to irradiate writing light (image light) based on input image data on the display medium 1 by the light source 32A, and controls the voltage applying unit 26 to apply an image writing pulse voltage across the transparent electrode 5 and the transparent electrode 6 at a timing (will be described in detail later). In this manner, the image is written in the display medium 1. An irradiation time of writing light (writing light irradiation time) T_{W} is expressed by a value (L_{W}/v′) obtained by dividing a moving distance L_{W} of the light irradiation unit 32 for the writing by the speed v′. In this manner, a total time for which light is irradiated is the writing light irradiation time T_{W}. An irradiation time of one pixel is expressed by a value (T_{W}/(L_{l /L}_{P})) obtained by dividing the writing light irradiation time T_{W} by a value obtained by dividing the moving distance L_{W} by a pixel length Lₚ.

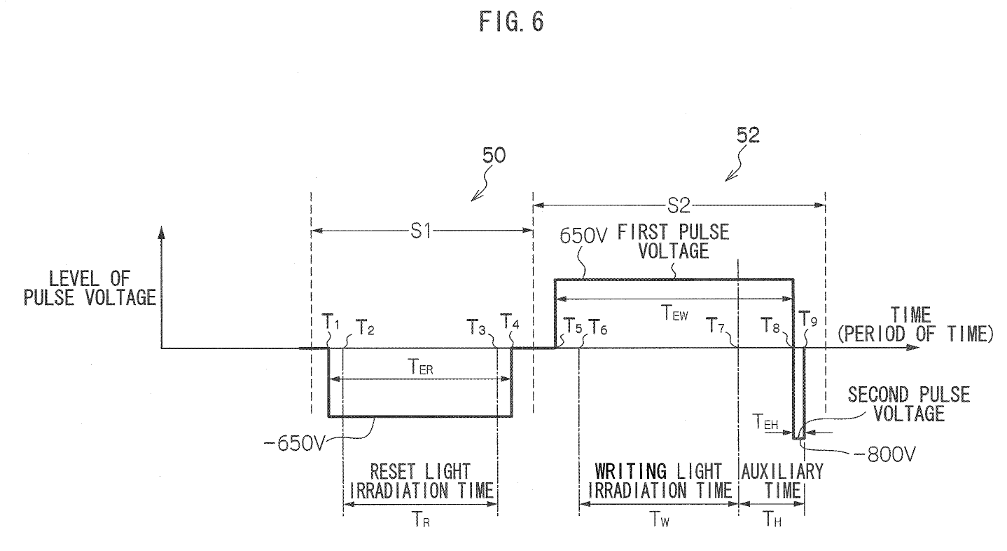

The resetting pulse voltage used in resetting and an image writing pulse voltage used in image writing applied across the transparent electrode 5 and the transparent electrode 6 by the voltage applying unit 26 controlled by the control unit 30 will be described below with reference to FIG. 6. FIG. 6 shows a waveform 50 of the resetting pulse voltage and a waveform 52 of the image writing pulse voltage in the exemplary embodiment. As shown in FIG. 6, a waveform in a section S1 is the waveform 50 of the resetting pulse voltage, and a waveform in a section S2 is a waveform 52 of the image writing pulse voltage. As shown in FIG. 6, a negative square-wave pulse voltage (voltage of −650 V in the example in FIG. 6) is applied across the transparent electrode 5 and the transparent electrode 6 for a period of time T₁ to T₄. The period of time T₂ to T₃ is the reset light irradiation time T_{R}; time T₂ is a time after time T₁, and time T₃ is a time before time T₄. Application of the resetting pulse voltage is started before the reset light is irradiated. After the irradiation of the reset light is ended, the application of the resetting pulse voltage is ended.

As shown in FIG. 6, a positive square-wave pulse voltage (first pulse voltage; a voltage of 650 V in the example in FIG. 6) is applied across the transparent electrode 5 and the transparent electrode 6 for a period of time T₅ to T₈. The period of time T₆ to T₇ is the writing light irradiation time T_{W}; time T₆ is a time after time T₅, and time T₇ is a time before time T₈. Application of the image writing pulse voltage is started before the writing light is irradiated. Even after the irradiation of the writing light is ended, application of the image writing pulse voltage is continued. As shown in FIG. 6, for a period of time T₈ to T₉, a negative square-wave pulse voltage (second pulse voltage; a voltage of −800 V in the example in FIG. 6) whose polarity is opposite to the polarity of the first pulse voltage is applied across the transparent electrode 5 and the transparent electrode 6. In the exemplary embodiment, an absolute value of a level (voltage) of the second pulse voltage is set to be higher (larger) than an absolute value of the level (voltage) of the first pulse voltage.

An image writing operation to the display medium 1 will be described below. The moving speeds (sub-scanning speeds) of the light irradiation unit 32 are represented by v and v′ (mm/s), respectively.

The control unit 30 designates the drive unit 24 to start movement of the light irradiation unit 32 in the direction of the arrow B in FIG. 2. The light irradiation unit 32 is arranged at a predetermined standby position before the reset operation is started. The standby position is located on an upstream side of an upstream-side end of the display medium 1 in the direction of the arrow B.

When the control unit 30 designates the drive unit 24 to start movement of the light irradiation unit 32, the drive unit 24 starts movement of the light irradiation unit 32. In this manner, the light irradiation unit 32 starts movement at the predetermined moving speed v in the direction of the arrow B in FIG. 2.

The control unit 30 controls the voltage applying unit 26 at a point in time (T₁ in the example in FIG. 6) before the point in time at which irradiation of the reset light is started by the light irradiation unit 32 (T₂ in the example in FIG. 6), that is, at a point in time before the light source 32A reaches the upstream end of the electrode 5 in the direction of the arrow B, such that the resetting pulse voltage is applied to the electrode 5 for a predetermined period of time T_{ER} (T₁ to T₄ in the example in FIG. 6). The control unit 30 outputs data (information) representing reset light to the light source 32A for a period of time T_{R} (T₂ to T₃ in the example in FIG. 6) from a point in time (T₂ in the example in FIG. 6) at which irradiation of reset light is started by the light source 32A to a point in time at which the irradiation period of the reset light is ended (T₃ in the example in FIG. 6), that is, a period of time from a point in time at which the light source 32A reaches the upstream end of the electrode 5 in the direction of the arrow B to a point in time at which the light source 32A reaches a downstream end of the electrode 5 in the direction of the arrow B. In this manner, a reset light is irradiated for the reset light irradiation time T_{R} from T₂ to T₃, and the display medium 1 is reset.

Upon completion of the reset operation, the control unit 30 controls the voltage applying unit 26 at a point in time (T₅ in the example in FIG. 6) before a point in time at which irradiation of the writing light (image light) is started by the light source 32A (T₆ in the example in FIG. 6), that is, at a point in time before the light source 32A reaches the upstream end of the electrode 5 in the direction of the arrow A, such that a first pulse voltage of the image writing pulse voltage is applied across the transparent electrode 5 and the transparent electrode 6 for a predetermined period of time T_{EW} (T₅ to T₈ in the example in FIG. 6). In this manner, the voltage applying unit 26 applies the first pulse voltage across the transparent electrode 5 and the transparent electrode 6 for the predetermined period of time T_{EW}. The period of time T_{EW}, as shown in FIG. 6, is longer than the writing light irradiation time T_{W}. The control unit 30 outputs to the light source 32A image data of an image to be written in a region of the electrode 5 of input data for a period of time T_{W} (T₆ to T₇ in the example in FIG. 6) from a point in time (T₆ in the example in FIG. 6) at which irradiation of writing light is started by the light source 32A to a point in time at which the irradiation of the writing light is ended (T₇ in the example in FIG. 6), that is, a period of time from a point in time at which the light source 32A reaches the upstream end of the electrode 5 in the direction of the arrow A to a point in time at which the light source 32A reaches a downstream end of the electrode 5 in the direction of the arrow A. In this manner, writing light based on image data is irradiated for the writing light irradiation time T_{W} from T₆ to T₇, and the image is written. For example, the state of a region on which the writing light is irradiated is changed from the F state into the H state. Naturally, image light is not irradiated on a region in which an image is not written. The control unit 30 controls the voltage applying unit 26 at a point in time (T₈ in the example in FIG. 6) at which the application of the first pulse voltage is ended such that a second pulse voltage of the image writing pulse voltage is applied across the transparent electrode 5 and the transparent electrode 6 for a predetermined period of time T_{EH} (T₈ to T₉ in the example in FIG. 6). In this manner, the second pulse voltage is applied across the transparent electrode 5 and the transparent electrode 6 by the voltage applying unit 26 for the predetermined period of time T_{EH} to attenuate an electric field intensity of the display layer 7.

An auxiliary time T_{H} (T₇ to T₉ in the example in FIG. 6) is a remaining period of time after the writing light irradiation time T_{W}, in the periods of time in which the first pulse voltage and the second pulse voltage are applied.

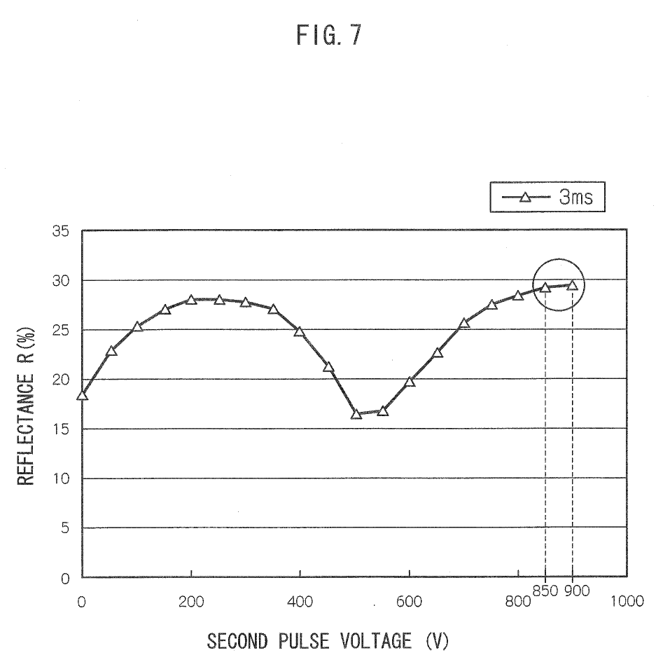

In the optical writing apparatus 2 in the exemplary embodiment, the voltage of the first pulse voltage is set to 650 V, and a voltage V_{P} of the second pulse voltage is changed within a predetermined range of 0 V to 900 V, so that an image is written on the display medium 1. In this case, a reflectance R (%) of the display layer 7 in the light irradiated region of the display medium 1 will be described below with reference to FIG. 7. As shown in FIG. 7, when the voltage V_{P} of the second pulse voltage is set to 850 V or more, a preferable reflectance is obtained in comparison with the case in which the absolute value of the voltage V_{P} of the second pulse voltage is set to be lower than the magnitude (level) of the first pulse voltage (corresponding voltage is 0 V to 650 V). In this case, since the voltage of the first pulse voltage is 650 V, the absolute value of the magnitude (level) of the second pulse voltage is desirably approximately 1.3 (850÷650) or more times the absolute value of the magnitude (level) of the first pulse voltage.

As described above, the optical writing apparatus 2 includes: the irradiation unit 32 serving as an irradiation means which irradiates writing light on the photoconductor layer 10 of the optical writing image display medium 1 including the photoconductor layer 10 in which an electric resistance is changed according to a light amount of irradiated writing light and the display layer 7 which displays an image by reflecting and transmitting light having a wavelength according to a magnitude of a voltage applied through the photoconductor layer 10 to display an image; the voltage applying unit 26 serving as a voltage applying means which applies an image writing pulse voltage to the display layer 7 and the photoconductor layer 10; and control unit 30 serving as a control means which, at the time of image writing, controls the irradiation unit 32 such that the writing light is irradiated on the photoconductor layer 10 at the time interval T_{W} at which the writing light is irradiated, and which controls the voltage applying unit 26 such that the first pulse voltage is applied to the display layer 7 and the photoconductor layer 10 at the interval (range) longer than the time interval T_{W} and the second pulse voltage whose polarity is opposite to the polarity of the first pulse voltage and whose absolute value (voltage level) is larger (higher) than the voltage (level) of the first pulse voltage (corresponding voltage is for example, −850 V) is applied after application of the first pulse voltage.

In the exemplary embodiment, the case in which a cholesteric liquid crystal is used as a display layer is explained. However, the display layer is not limited to the cholesteric liquid crystal, a ferroelectric liquid crystal may be used.

In the exemplary embodiment, it is explained that the display medium 1 is fixed and the light irradiation unit 32 is moved such that the light irradiation unit 32 moves relatively to the display medium 1. However, the display medium 1 may be moved while the light irradiation unit 32 is fixed, or both the light irradiation unit 32 and the display medium 1 may be moved such that the light irradiation unit 32 moves relatively to the display medium 1.

### Second Exemplary Embodiment

A second exemplary embodiment will be described below. The same reference numerals as in the first exemplary embodiment denote the same components and similar processes in the second exemplary embodiment, and a description thereof will be omitted. In the first exemplary embodiment, the example in which the first pulse voltage and the second pulse voltage are applied is explained. However, in the second exemplary embodiment, a first pulse voltage, a second pulse voltage, and a third pulse voltage are applied.

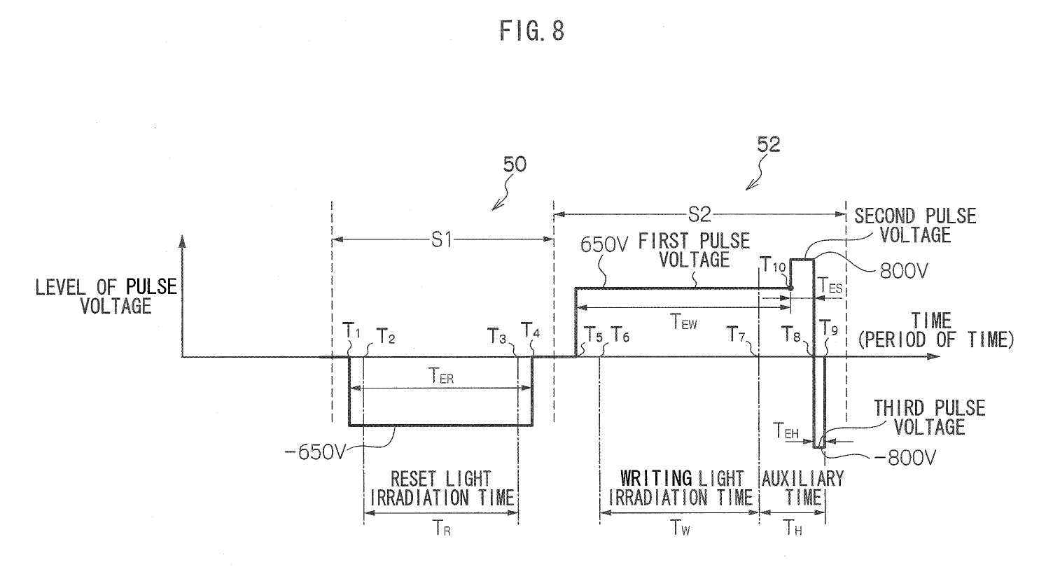

As shown in FIG. 8, in the exemplary embodiment, a positive square-wave pulse voltage (first pulse voltage; a voltage of 650 V in the example in FIG. 8) is applied to the transparent electrode 5 and the transparent electrode 6 in a period of time T₅ to T₁₀. As shown in FIG. 8, a positive square-wave pulse voltage (second pulse voltage; a voltage of 800 V in the example in FIG. 8) having the same polarity as that of the first pulse voltage is applied across the transparent electrode 5 and the transparent electrode 6 in a period of time T₈ to T₁₀. In the exemplary embodiment, an absolute value of the level (voltage) of the second pulse voltage is higher (larger) than an absolute value of a level (voltage) of the first pulse voltage. As shown in FIG. 8, a negative square-wave pulse voltage (third pulse voltage; a voltage of −800 V in the example in FIG. 8) whose polarity is opposite to the polarity of the first pulse voltage is applied across the transparent electrode 5 and the transparent electrode 6 for a period of time T₈ to T₉. In the exemplary embodiment, the absolute value of a level (voltage) of the third pulse voltage is higher (larger) than the absolute value of the level (voltage) of the first pulse voltage.

An image writing operation to the display medium 1 in the exemplary embodiment will be described below. As in the first exemplary embodiment, moving speeds (sub-scaming speeds) of the light irradiation unit 32 are represented by v and v′ (mm/s), respectively.

The control unit 30 designates the drive unit 24 such that the light irradiation unit 32 starts movement in the direction of the arrow B in FIG. 2. The light irradiation unit 32 is arranged at a predetermined standby position before the reset operation is started. The standby position is located on an upstream side of an upstream-side end of the display medium 1 in the direction of the arrow B.

When the control unit 30 designates the drive unit 24 to start movement of the light irradiation unit 32, the drive unit 24 starts movement of the light irradiation unit 32. In this manner, the light irradiation unit 32 starts movement at the predetermined moving speed v in the direction of the arrow B in FIG. 2.

The control unit 30 controls the voltage applying unit 26 at a point in time (T₁ in the example in FIG. 8) before a point in time at which irradiation of the reset light is started by the light irradiation unit 32 (T₂ in the example in FIG. 8), that is, at a point in time before the light source 32A reaches the upstream end of the electrode 5 in the direction of the arrow B, such that the resetting pulse voltage is applied to the electrode 5 for a predetermined period of time T_{ER} (T₁ to T₄ in the example in FIG. 8). The control unit 30 outputs data (information) representing reset light to the light source 32A for a period of time T_{R} (T₂ to T₃ in the example in FIG. 8) from a point in time (T₂ in the example in FIG. 8) at which irradiation of reset light is started by the light source 32A to a point in time at which the irradiation period of the reset light is ended (T₃ in the example in FIG. 8), that is, a period of time from a point in time at which the light source 32A reaches the upstream end of the electrode 5 in the direction of the arrow B to a point in time at which the light source 32A reaches a downstream end of the electrode 5 in the direction of the arrow B. In this manner, reset light is irradiated for the duration of the reset light irradiation time T_{R} from T₂ to T₃, and the display medium 1 is reset.

Upon completion of the reset operation, the control unit 30 controls the voltage applying unit 26 at a point in time (T₅ in the example in FIG. 8) before a point in time (T₆ in the example in FIG. 8) at which irradiation of the writing light (image light) is started by the light source 32A, that is, a point in time before the light source 32A reaches the upstream end of the electrode 5 in the direction of the arrow A, such that a first pulse voltage of the image writing pulse voltage is applied across the transparent electrode 5 and the transparent electrode 6 for a predetermined period of time T_{EW} (T₅ to T₁₀ in the example in FIG. 8). In this manner, the voltage applying unit 26 applies the first pulse voltage across the transparent electrode 5 and the transparent electrode 6 for the predetermined period of time T_{EW}. The period of time T_{EW}, as shown in FIG. 6, is longer than the writing light irradiation time T_{W}. The control unit 30 outputs to the light source 32A image data of an image to be written in a region of the electrode 5 of input image data for a period of time T_{W} (T₆ to T₇ in the example in FIG. 8) from a point in time (T₆ in the example in FIG. 8) at which irradiation of writing light is started by the light source 32A to a point in time at which the irradiation of the writing light is ended (T₇ in the example in FIG. 8), that is, a period of time from a point in time at which the light source 32A reaches the upstream end of the electrode 5 in the direction of the arrow A to a point in time at which the light source 32A reaches a downstream end of the transparent electrode 5 in the direction of the arrow A. In this manner, writing light based on image data is irradiated for the writing light irradiation time T_{W} from T₆ to T₇, and the image is written. For example, the state of a region on which the writing light is irradiated is changed from the F state into the H state. Naturally, image light is not irradiated on a region in which an image is not written. The control unit 30 controls the voltage applying unit 26 at a point in time (T₁₀ in the example in FIG. 8) at which the application of the first pulse voltage is ended, such that a second pulse voltage of the image writing pulse voltage is applied across the transparent electrode 5 and the transparent electrode 6 for a predetermined period of time T_{ES} (T₁₀ to T₈ in the example in FIG. 8). In this manner, the second pulse voltage is applied across the transparent electrode 5 and the transparent electrode 6 by the voltage applying unit 26 for the predetermined period of time T_{ES}. At a point in time at Which the application of the second pulse voltage is ended (T₈ in the example in FIG. 8), the control unit 30 controls the voltage applying unit 26 such that a third pulse voltage of the image writing pulse voltage is applied across the transparent electrode 5 and the transparent electrode 6 for a predetermined period of time T_{EH} (T₈ to T₉ in the example in FIG. 8). In this manner, the voltage applying unit 26 applies the third pulse voltage across the transparent electrode 5 and the transparent electrode 6 for the predetermined period of time T_{EH} to attenuate an electric field intensity of the display layer 7.

An auxiliary time T_{H} (T₇ to T₉ in the example in FIG. 8) is a remaining period of time after the writing light irradiation time T_{W}, in the periods of time in which the first pulse voltage, the second pulse voltage, and the third pulse voltage are applied.

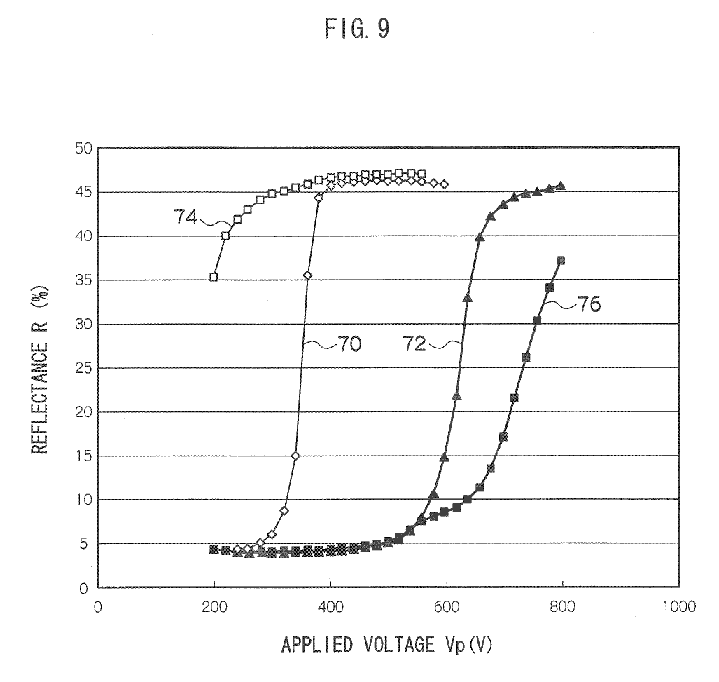

In the optical writing apparatus 2 in the exemplary embodiment, the voltage of the second pulse voltage is set to 800 V, the voltage of the third pulse voltage is set to −800 V, and a voltage V_{P} of the first pulse voltage is changed within a predetermined range of 200 V to 800 V, so that an image is written on the display medium 1. In this case, a reflectance R (%) of the display layer 7 in the light irradiated region of the display medium 1 will be described below with reference to FIG. 9. In FIG. 9, a graph 70 indicating the reflectance R of the display layer 7 in an irradiation state when the voltage of the second pulse voltage is set to be equal to the voltage of the first pulse voltage and the absolute value of the level of the third pulse voltage is smaller than the absolute value of the level of the first pulse voltage, a graph 72 indicating the reflectance R of the display layer 7 in a non-irradiation state when the voltage of the second pulse voltage is set to be equal to the voltage of the first pulse voltage and the absolute value of the level of the third pulse voltage is lower than the absolute value of the level of the first pulse voltage, a graph 74 indicating the reflectance R of the display layer 7 in an irradiation state when the voltage of the second pulse voltage is set to 800 V and the voltage of the third pulse voltage is set to −800 V, and a graph 76 indicating the reflectance R of the display layer 7 in a non-irradiation state when the voltage of the second pulse voltage is set to 800 V and the voltage of the third pulse voltage is set to −800 V are shown. As shown in the graphs 70, 72, 74, and 76, it is apparent that a latitude (range of a pulse voltage used when an image is written by the optical writing apparatus) of a writing voltage of the optical writing apparatus 2 according to the exemplary embodiment is wider than that in a conventional art.

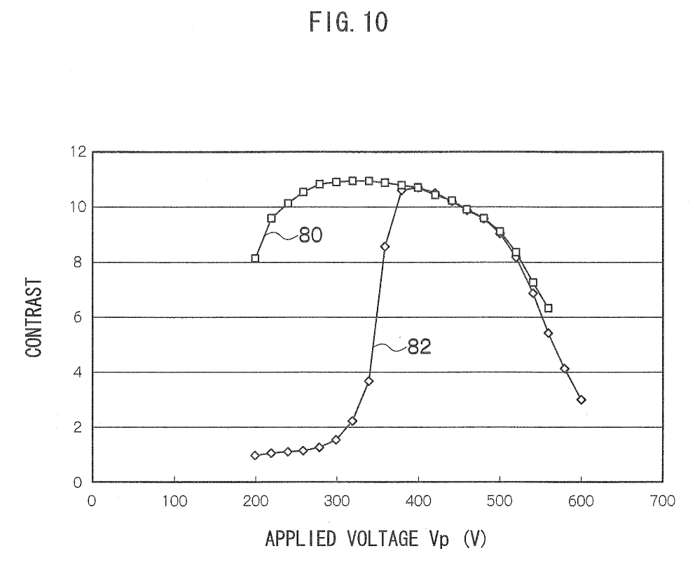

The voltage of the second pulse voltage is set to 800 V, the voltage of the third pulse voltage is set to −800 V, and the voltage V_{P} of the first pulse voltage is changed within a predetermined range of 200 V to 600 V, so that an image is written in the display medium 1. In this case, contrasts of the display layer 7 of the display medium 1 will be described below with reference to FIG. 10. In FIG. 10, a graph 80 indicating a contrast of the display layer 7 when the voltage of the second pulse voltage is set to be equal to the voltage of the first pulse voltage and the absolute value of the level of the third pulse voltage is smaller than the absolute value of the level of the first pulse voltage, and a graph 82 indicating a contrast of the display layer 7 when the voltage of the second pulse voltage is set to 800 V and the voltage of the third pulse voltage is set to −800 V are shown. As shown in the graphs 80 and 81, it is apparent that a contrast of an image on the display medium 1 written by the optical writing apparatus 2 according to the exemplary embodiment is preferable in comparison to that of a conventional art.

As described above, the optical writing apparatus 2 according to the exemplary embodiment including: the irradiation unit 32 serving as an irradiation means which irradiates writing light on the photoconductor layer 10 of the optical writing image display medium 1 including the photoconductor layer 10 in which an electric resistance is changed according to a light amount of irradiated writing light and the display layer 7 which displays an image by reflecting and transmitting light having a wavelength according to a magnitude of a voltage applied through the photoconductor layer 10 to display an image; the voltage applying unit 26 serving as a voltage applying means which applies an image writing pulse voltage to the display layer 7 and the photoconductor layer 10; and control unit 30 serving as a control means which, at the time of image writing, controls the irradiation unit 32 such that the writing light is irradiated on the photoconductor layer 10 at the time interval T_{W} at which the writing light is irradiated, and which controls the voltage applying unit 26 such that the first pulse voltage is applied to the display layer 7 and the photoconductor layer 10 at the interval (range) longer than the time interval T_{W}, the second pulse voltage whose polarity is same to the polarity of the first pulse voltage and whose absolute value (voltage level) is larger (higher) than the voltage (level) of the first pulse voltage (corresponding voltage is for example, 850 V) is applied after application of the first pulse voltage, and the third pulse voltage whose polarity is opposite to the polarity of the first pulse voltage and whose absolute value (voltage level) is larger (higher) than the voltage (level) of the first pulse voltage (corresponding voltage is for example, −850 V) is applied after application of the second pulse voltage.

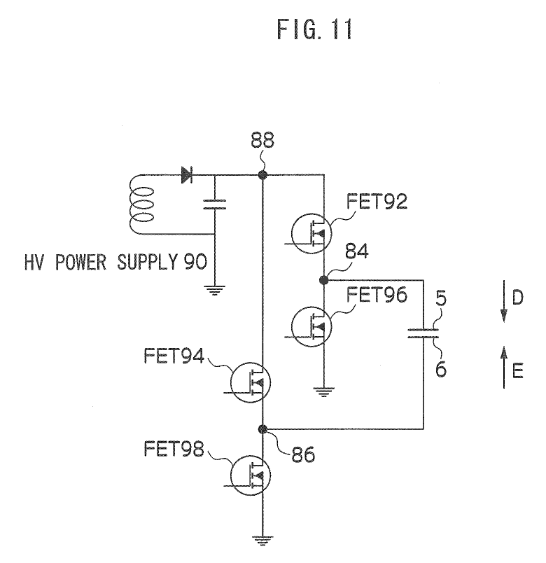

In the first embodiment and the second embodiment, the voltage applying unit 26, as shown in FIG. 1 1, may includes a high-voltage power supply 90 and an FET 92, an FET 94, an FET 96, and an FET 98 which serve as switching elements. For example, the following configuration may be used. More specifically, as shown in FIG. 11, the high-voltage power supply 90 is connected to a drain electrode of the FET 92 through a node 88, and a drain electrode of the FET 96 and the transparent electrode 5 are connected to the source electrode of the FET 92 through a node 84. A source electrode of the FET 96 is grounded. The high-voltage power supply 90 is connected to a drain electrode of the FET 94 through a node 88, and a drain electrode of the FET 98 and the transparent electrode 6 are connected to a source electrode of the FET 94 through a node 86. A source electrode of the FET 98 is grounded. The control unit 30 is connected to the gate electrodes of the FETs. In the above configuration, the control unit 30 turns on the FET 92 and the FET 98 and turns off the FIT 94 and the FET 96 to allow a current flow in a direction of an arrow D shown in FIG. 11. The control unit 30 turns off the FET 92 and the FET 98 and turns on the FET 94 and the FET 96 to allow a current to flow in a direction of an arrow E shown in FIG. 11. In this manner, the directions of a voltage to be applied across the transparent electrode 5 and the transparent electrode 6 can be switched with a simple configuration without using two positive and negative power supplies.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An optical writing apparatus comprising:
an irradiation unit which irradiates a writing light on a photoconductor layer of an optical writing image display medium, the optical writing image display medium comprising the photoconductor layer, which has an electrical resistance which is changed according to a light amount of an irradiated writing light, and further comprising a display layer which displays an image by reflecting and transmitting light having a wavelength according to a magnitude of a voltage applied through the photoconductor layer;
a voltage applying unit which applies an image writing pulse voltage to the display layer and the photoconductor layer; and
a control unit which, at the time of image writing, controls the irradiation unit such that, at a first time interval at which the writing light is irradiated, the writing light is irradiated on the photoconductor layer, and which controls the voltage applying unit such that a first pulse voltage is applied to the display layer and the photoconductor layer at an interval which is longer than the first time interval, and such that a second pulse voltage whose polarity is opposite to a polarity of the first pulse voltage and whose absolute value is larger than an absolute value of the first pulse voltage is applied after application of the first pulse voltage.

2. The optical writing apparatus of claim 1, wherein the absolute value of the second pulse voltage is approximately 1.3 times the absolute value of the first pulse voltage, or greater.

3. An optical writing apparatus comprising:
an irradiation unit which irradiates writing light on a photoconductor layer of an optical writing image display medium, the optical writing image display medium comprising the photoconductor layer, in which an electrical resistance is changed according to a light amount of irradiated writing light, and a display layer which displays an image by reflecting and transmitting light having a wavelength according to a magnitude of a voltage applied through the photoconductor layer;
a voltage applying unit which applies an image writing pulse voltage to the display layer and the photoconductor layer; and
a control unit which, at a time of image writing, controls the irradiation unit such that, at a first time interval at which the writing light is irradiated, the writing light is irradiated on the photoconductor layer, and which controls the voltage applying unit such that a first pulse voltage is applied to the display layer and the photoconductor layer at an interval which is longer than the first time interval, a second pulse voltage whose polarity is same to a polarity of the first pulse voltage and whose absolute value is larger than an absolute value of the first pulse voltage is applied to the display layer and the photoconductor layer after application of the first pulse voltage, and a third pulse voltage whose polarity is opposite to the polarity of the first pulse voltage and whose absolute value is larger than the absolute value of the first pulse voltage is applied after application of the second pulse voltage.

4. An optical writing method comprising:
irradiating a writing light on a photoconductor layer of an optical writing image display medium comprising the photoconductor layer, which has an electrical resistance which is changed according to a light amount of the irradiated writing light, and a display layer which displays an image by reflecting and transmitting light having a wavelength according to a magnitude of a voltage applied through the photoconductor layer, such that, at a time of image writing, at a first time interval at which the writing light is irradiated, the writing light is irradiated on the photoconductor layer; and
applying an image writing pulse voltage to the display layer and the photoconductor layer such that a first pulse voltage is applied to the display layer and the photoconductor layer at an interval which is longer than the first time interval, and such that a second pulse voltage whose polarity is opposite to a polarity of the first pulse voltage and whose absolute value is larger than an absolute value of the first pulse voltage is applied after application of the first pulse voltage.

5. An optical writing method comprising:
irradiating writing light on a photoconductor layer of an optical writing image display medium comprising the photoconductor layer, which has an electrical resistance which is changed according to a light amount of the irradiated writing light, and a display layer which displays an image by reflecting and transmitting light having a wavelength according to a magnitude of a voltage applied through the photoconductor layer, such that, at a time of image writing at a first time interval at which the writing light is irradiated, the writing light is irradiated on the photoconductor layer; and
applying an image writing pulse voltage to the display layer and the photoconductor layer such that a first pulse voltage is applied to the display layer and the photoconductor layer at an interval which is longer than the first time interval, a second pulse voltage, whose polarity is to the same as a polarity of the first pulse voltage and whose absolute value is larger than an absolute value of the first pulse voltage, is applied to the display layer and the photoconductor layer after application of the first pulse voltage, and a third pulse voltage whose polarity is opposite to the polarity of the first pulse voltage and whose absolute value is larger than the absolute value of the first pulse voltage is applied after application of the second pulse voltage.

6. A recording medium recorded with a program that performs optical writing by a computer, the program comprising:
irradiating writing light on a photoconductor layer of an optical writing image display medium comprising the photoconductor layer, which has an electrical resistance that changes according to a light amount of the irradiated writing light, and a display layer which displays an image by reflecting and transmitting light having a wavelength according to a magnitude of a voltage applied through the photoconductor layer, such that, at a time of image writing, at a first time interval at which the writing light is irradiated, the writing light is irradiated on the photoconductor layer; and
applying an image writing pulse voltage to the display layer and the photoconductor layer such that a first pulse voltage is applied to the display layer and the photoconductor layer at an interval which is longer than the first time interval, and such that a second pulse voltage whose polarity is opposite to a polarity of the first pulse voltage and whose absolute value is larger than an absolute value of the first pulse voltage is applied after application of the first pulse voltage.

7. A recording medium recorded with a program that performs optical writing by a computer, the program comprising:
irradiating writing light on a photoconductor layer of an optical writing image display medium comprising the photoconductor layer, which has an electrical resistance which changes according to light amount of the irradiated writing light, and a display layer which displays an image by reflecting and transmitting light having a wavelength according to a magnitude of a voltage applied through the photoconductor layer, such that, at a time of image writing, at a first time interval at which the writing light is irradiated, the writing light is irradiated on the photoconductor layer; and
applying an image writing pulse voltage to the display layer and the photoconductor layer such that a first pulse voltage is applied to the display layer and the photoconductor layer at an interval which is longer than the first time interval, a second pulse voltage whose polarity is the same as a polarity of the first pulse voltage and whose absolute value is larger than an absolute value of the first pulse voltage, is applied to the display layer and the photoconductor layer after application of the first pulse voltage, and a third pulse voltage whose polarity is opposite to the polarity of the first pulse voltage and whose absolute value is larger than the absolute value of the first pulse voltage is applied after application of the second pulse voltage.
